(19) United States
(12) Patent Application Publication
(10) Pub. No.: US 2005/0097755 A1
(43) Pub. Date: May 12, 2005

(54) Folding knife having a locking mechanism

(76) Inventors: Timothy James Galyean, Canby, OR (US); Kenneth J. Onion, Kaneohe, HI (US)

Correspondence Address: KOLISCH HARTWELL, P.C., 520 S.W. YAMHILL STREET, SUITE 200, PORTLAND, OR, 97204, US

(21) Appl. No.: 10/980,149

(22) Filed: Nov. 1, 2004

Related U.S. Application Data
(60) Provisional application No. 60/516,347, filed on Oct. 31, 2003.

(51) Int. Cl. B26B 1/02

(52) U.S. Cl. 30/161

(57) ABSTRACT

A folding knife is disclosed. The folding knife includes a handle; a blade pivotally connected to the handle in a manner allowing pivoting of the blade between a closed position in which the blade extends along the handle, and an open position in which the blade extends away from the handle, wherein the blade includes a tang having a first locking element; a second locking element disposed within the handle; and a third locking element configured to move between a locking position in which the third locking element engages the first locking element and the second locking element in a manner preventing pivoting of the blade relative to the handle, and an unlocking position in which the blade is free to pivot from the closed position to the open position, wherein the third locking element is configured to move free from a bias element.

### CROSS-REFERENCE TO RELATED APPLICATIONS

This application claims priority under 35 U.S.C. §119(e) to U.S. Provisional Patent Application Ser. No. 60/516,347 entitled “Folding Knife With Safety Lock,” filed Oct. 31, 2003, the entire disclosure of which is herein incorporated by reference for all purposes.

### TECHNICAL FIELD

The present disclosure relates generally to a folding knife, and particularly to a folding knife with a locking mechanism.

### BACKGROUND

Folding knives enjoy wide popularity, particularly among sportsmen, campers, hikers, and many others engaged in outdoor activities. Common elements to folding knives include a handle and a blade pivotally connected to an end of the handle so that the blade pivots with respect to the handle between an open position in which the blade is extended away from the handle, and a closed position in which the blade is at least partially received within the handle. Many folding knives also include a locking mechanism to maintain the blade in the open position and/or the closed position.

Examples of folding knives, including folding knives with locking mechanisms, may be found in may be found in U.S. Pat. Nos. 1,454,665; 1,743,022; 4,040,081; 4,173,068; 4,404,748; 4,451,982; 4,502,221; 4,719,700; 4,805,303; 4,811,486; 4,837,932; 4,893,409; 4,974,323; 4,979,301; 5,044,079; 5,060,379; 5,095,624; 5,111,581; 5,293,690; 5,325,588; 5,331,741; 5,425,175; 5,502,895; 5,515,610; 5,537,750; 5,546,662; 5,596,808; 5,615,484; 5,685,079; 5,689,885; 5,692,304; 5,737,841; 5,755,035; 5,802,722; 5,822,866; 5,826,340; 5,887,347; 5,964,036; 6,079,106; 6,154,965; 6,338,431; 6,378,214; 6,427,335; 6,438,848; 6,490,797; D348,599, and D373,296; and U.S. Patent Application Nos. 2002/0157260 and 2003/0070299, the entire disclosures of which are herein incorporated by reference for all purposes.

### SUMMARY

One embodiment provides a folding knife. The folding knife includes a handle; a blade pivotally connected to the handle in a manner allowing pivoting of the blade between a closed position in which the blade extends along the handle, and an open position in which the blade extends away from the handle, wherein the blade includes a tang having a first locking element; a second locking element disposed within the handle; and a third locking element configured to move between a locking position in which the third locking element engages at least part of the first locking element and at least part of the second locking element in a manner preventing pivoting of the blade relative to the handle, and an unlocking position in which the blade is free to pivot from the closed position to the open position, wherein the third locking element is configured to move free from a bias element.

### BRIEF DESCRIPTION OF THE DRAWINGS

FIG. 1 is side view of a folding knife incorporating an example of a locking mechanism.

FIG. 2 is a front plan view of the folding knife of FIG. 1.

FIG. 3 is a side view of the knife in FIG. 1, shown without a handle side panel and a spacer to illustrate the locking mechanism.

FIG. 4 is an exploded view of the folding knife of FIG. 1.

FIG. 5 is a cross-sectional view of the folding knife of FIG. 1 taken along line 5-5 illustrating the locking mechanism in a locked position.

FIG. 6 is the same view as FIG. 5 illustrating the locking mechanism in an unlocked position.

FIG. 7 is an exploded view of a folding knife with another example of a locking mechanism.

FIG. 8 is a cross-sectional view of the folding knife of FIG. 1 taken along line 8-8 illustrating the locking mechanism shown in FIG. 7 in a locked position.

FIG. 9 is the same view as FIG. 8 illustrating the locking mechanism in an unlocked position.

### DESCRIPTION

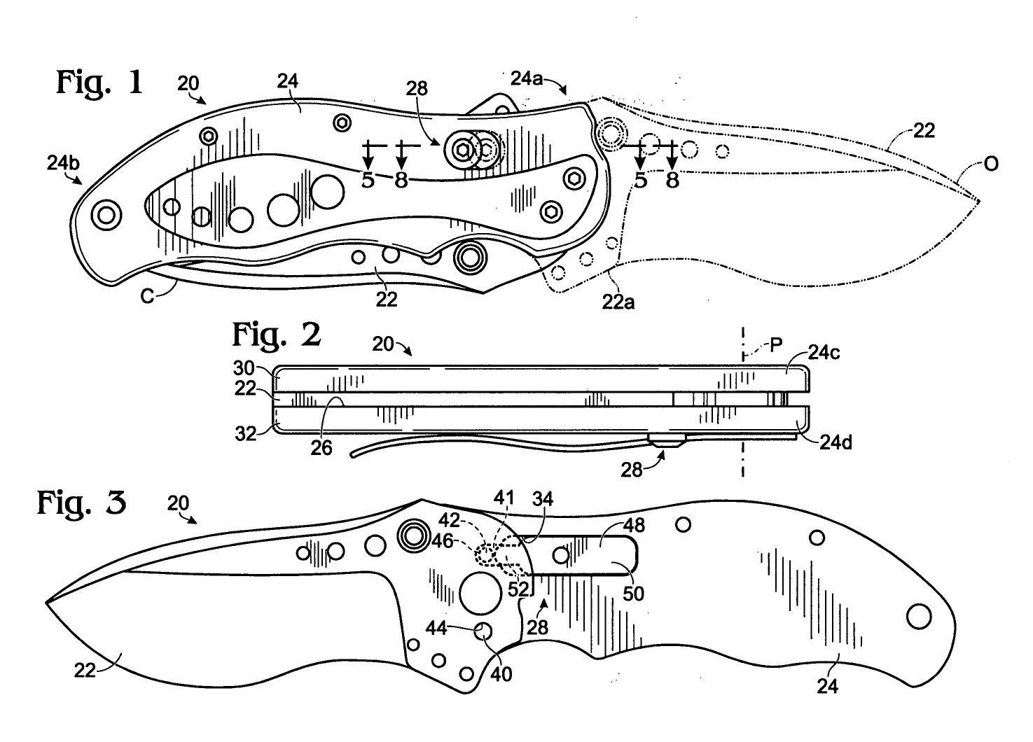

FIGS. 1-2 depict an embodiment of a folding knife 20 having a blade 22, a handle 24 defining a blade-receiving channel 26, and a locking mechanism 28. Blade 22 includes a tang 22a pivotally connected to an end 24a of handle 24. The blade may be generally planar and may pivot with respect to the handle about a pivot axis P between an open position O and a closed position C. In the open position, the blade extends away from the handle, where it is deployed and ready for use. From the open position, the blade may be folded towards the handle, pivoting about pivot axis P, into the closed position, in that position the blade may be at least partially received for storage within blade-receiving channel 26. In the closed position, blade 22 extends at least partially along handle 24.

Handle 24 may include a pivot-end portion 24a, an opposing-end portion 24b, and first and second handle sides 24c and 24d, as shown in FIG. 2. Tang 22a of blade 22 may be pivotally connected to handle 24 at pivot-end portion 24a. One or both of handle sides 24c and 24d also may include a respective handle side panel, such as opposite handle side panels 30 and 32. Handle side panels 30 and 32 may be any suitable shape or structure and may be configured to provide locations for various components internal to handle 24 and/or to provide access to those various components.

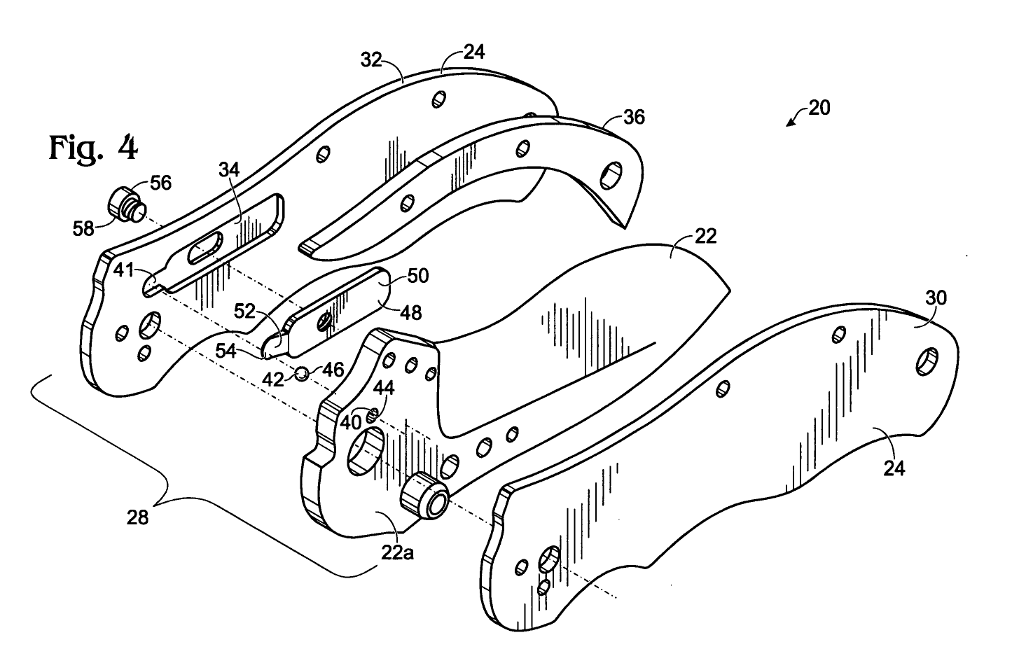

Additionally, handle 24 may include one or more handle liners (not shown), which may be any suitable shape or structure and may conform to the shape of handle side panels 30 and 32. Although the knife discussed and shown in FIGS. 1-2 includes two handle side panels, any suitable combination and configuration of handle side panels and liners may be used. Furthermore, handle 24 may include one or more spacers 36 shown in FIG. 4, which may be any suitable shape or structure and may conform to the shape of handle side panels 30 and 32. Although the knife discussed and shown in FIGS. 1-4 includes one spacer, any suitable number of spacers may be used.

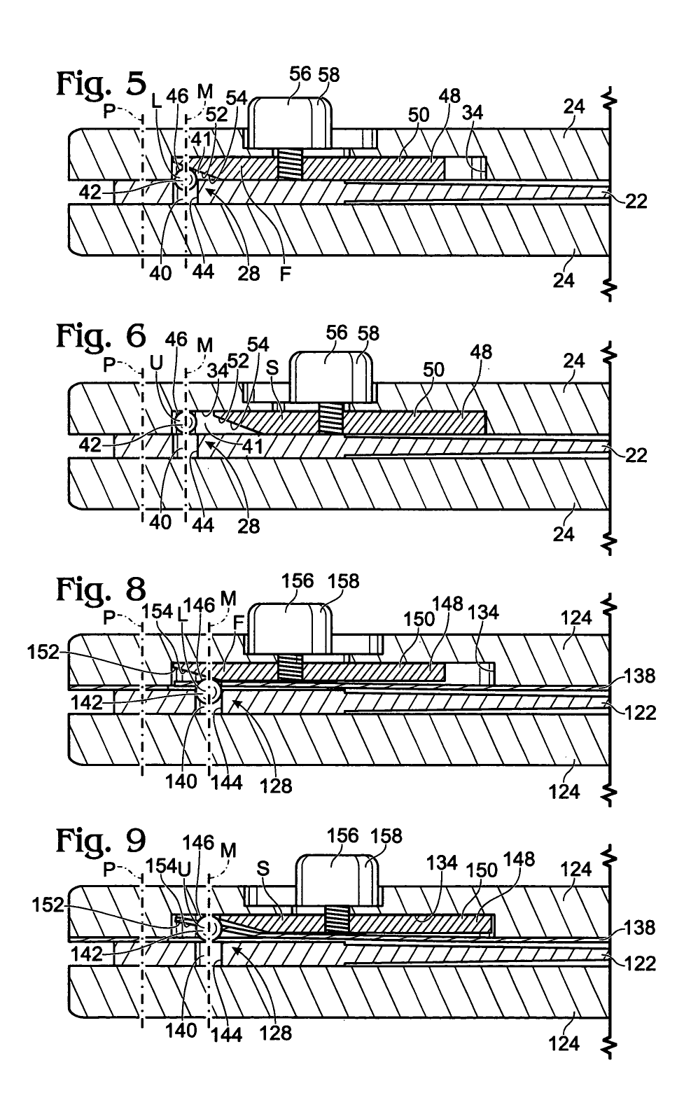

Locking mechanism 28 may include a first locking element 40, a second locking element 41, and a third locking element 42. First locking element 40 may include any structure configured to be engaged by third locking element 42 and selectively lock blade 22 in the closed position and/or open position. For example, as shown in FIGS. 3-6, the first locking element may be in the form of a hole 44.

Although first locking element 40 is discussed as including a hole on tang 22a of blade 22, any suitable structure configured to interact with at least part of third locking element 42 to selectively lock blade 22 in the closed position and/or the open position may be used, such as latching elements, locking cutouts, notches, or mechanical, magnetic, or electronic devices, or the like. Additionally, although first locking element 40 is shown to include one hole 44, the first locking element may include two or more holes to selectively lock blade 22 in different positions.

Second locking element 41 may include any structure configured to be engaged by third locking element 42 to selectively lock blade 22 in the closed position and/or the open position. For example, as shown in FIGS. 3-6, the second locking element may include a recess 34 within handle 24. Although second locking element 41 is discussed as including a recess 34 within handle 24, any suitable structure configured to interact with at least part of third locking element 42 to selectively lock blade 22 in the open and/or closed position may be used, such as latching elements, locking cutouts, notches, or mechanical, magnetic, or electronic devices, or the like.

Third locking element 42 may include any structure configured to engage at least part of first locking element 40 and at least part of second locking element 41 to selectively lock blade 22 in the closed position and/or the open position. For example, shown in FIGS. 3-6, third locking element 42 may include a ball bearing 46. The ball bearing may engage or be disposed within recess 34 of handle 24. Third locking element 42 may move within slot 34 between a locking position L and an unlocking position U, the unlocking position being spaced further from first locking element 40 compared to the locking position. The second locking element may move along any suitable line or plane configured to allow it to engage at least part of first locking element 40. For example, third locking element 42 may move along a motion line M parallel to pivot axis P or transverse to the plane of the blade travel.

Although third locking element 42 is shown to be disposed within or engage first locking element 40 when the third locking element is in unlocking position U, third locking element 42 may alternatively engage or be disposed within second locking element 41 when the third locking element is in unlocking position U. For example, ball bearing 46 may be disposed within hole 44 of blade 22 when the ball bearing is in unlocking position U.

The third locking element may move between locking position L and unlocking position U free or without any bias element. Alternatively, a bias element (not shown) may urge third locking element 42 toward the locking position and/or the unlocking position. Although third locking element 42 is shown to include a ball bearing, any suitable structure configured to engage at least part of first locking element 40 and at least part of second locking element 41 to selectively lock blade 22 in the closed position and/or the open position may be used, such as latches or hooks, or mechanical, magnetic, or electronic devices, or the like.

Locking mechanism 28 also may include a follower member 48, which may include any suitable structure configured to move third locking element 42 between the locking position and the unlocking position. For example, as shown in FIGS. 3-6, follower member 48 may be in the form of a follower plate 50. The follower plate may be mounted for sliding movement in recess 34 of handle side panel 30 between a first position F and a second position S. In the first position, follower plate 50 moves third locking element 42, or allows third locking element 42 to move, into locking position L. In the second position, follower plate 50 moves third locking element 42, or allows third locking element 42 to move, into unlocking position U.

Follower plate 50 may include a contacting end portion 52 configured to contact third locking element 42 and move that element between the locking and the unlocking positions. For example, contacting end portion 52 may include an inclined surface 54 configured to move the third locking element, such as ball bearing 46, between locking position L and unlocking position U, as the follower plate is moved between the first position and the second position.

The follower plate also may include an actuator 56 manipulable from outside handle 24. The actuator may include any suitable structure configured to allow a user to slide follower plate 50 between the first position and the second position. For example, actuator 56 may be in the form of a screw 58, which allows the user to selectively slide follower plate 50 from outside handle 22. Additionally, actuator 56 may secure follower plate 50 within slot 34 of handle 22.

Although follower member 48 is shown to include a specific shape and structure, any suitable shape and structure may be used configured to move third locking element 42 between the locking position and the unlocking position. Additionally, although follower member 48 is shown to be slidingly mounted on handle 22, the follower member may be pivotally mounted or mounted in any other suitable way configured to move third locking element 42 between the locking position and the unlocking position. Furthermore, although follower member 48 is shown to move third locking element 42, the follower member may not be included in some embodiments of folding knife 20. For example, third locking element 42 may be configured to be manipulable from outside the handle or the blade such that the user may move the third locking element between the locking position and the unlocking position without the follower member.

An alternative embodiment of folding knife 20 is shown in FIG. 7. The illustrated folding knife may selectively include any of the elements, subelements, and variations as the other folding knives illustrated, described, or incorporated herein. Similar to the previously discussed embodiment, the illustrated folding knife may include a blade 122, a handle 124 partially received within blade-receiving channel 126, and a locking mechanism 128. Handle 124 may include one or more handle side panels, such as handle side panels 130 and 132, and one or more spacers, such as a spacer 136.

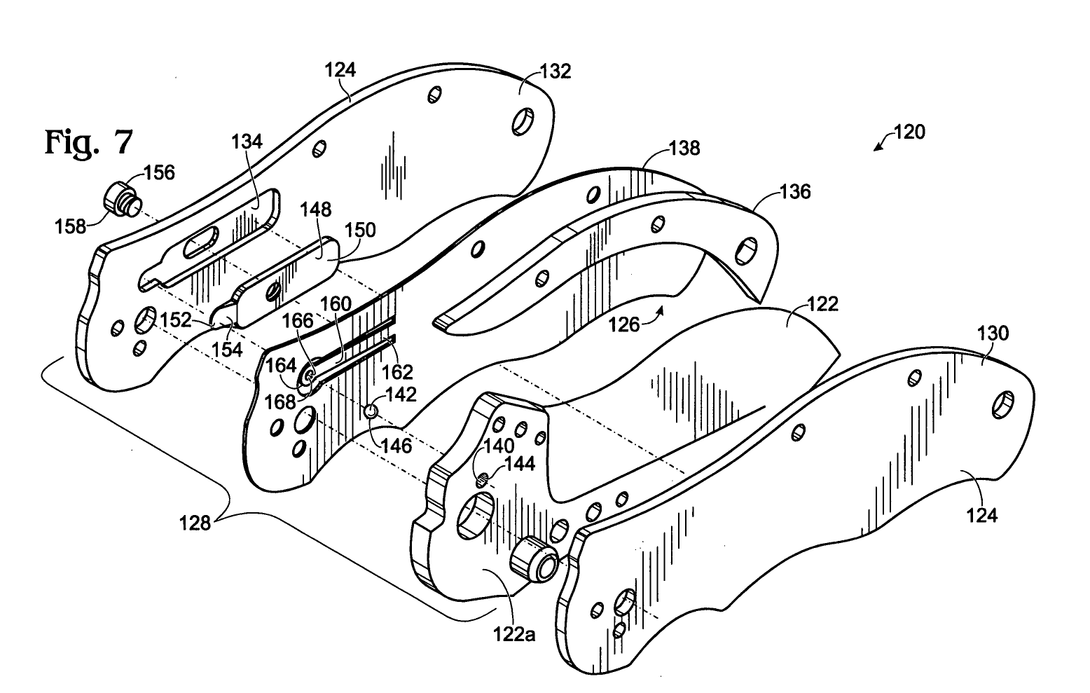

Locking mechanism 128 may include a first locking element 140 and a second locking element 142, as shown in FIGS. 7-9. First locking element 140 may include any structure configured to engage second locking element 142 and lock blade 122 in the closed and/or open position. For example, as shown in FIGS. 7-9, the first locking element may be in the form of a hole 144 on a tang 122a of blade 122. Although first locking element 140 is discussed as including a hole on the tang of blade 122, any suitable structure configured to interact with at least part of second locking element 142 to selectively lock blade 122 in the open and/or closed position may be used, such as latching elements, locking cutouts, notches, or mechanical, magnetic, or electronic devices, or the like.

Second locking element 142 may include any structure configured to lock blade 122 in the open position and/or the closed position. For example, as shown in FIGS. 7-9, the second locking element may include a ball bearing 146 disposed within a slot 134 of handle side panel 130 of handle 124. Second locking element 142 may move within slot 134 between a locking position L and an unlocking position U, the unlocking position being spaced further from first locking element 140 compared to the locking position. The second locking element may move along any suitable line or plane configured to allow it to engage at least part of first locking element 140. For example, second locking element 142 may move along a motion line M parallel to pivot axis P. Although second locking element 142 is shown to include a ball bearing, any suitable structure configured to engage at least part of first locking element 140 and selectively lock blade 122 in the open and/or closed position may be used, such as latches or hooks, or mechanical, magnetic, or electronic devices, or the like.

Locking mechanism 128 also may include a bias element 160, which includes any suitable structure configured to urge second locking element 142 toward unlocking position U or locking position L. For example, a leaf spring 162 may be formed from a liner 138 of handle 124. Second locking element 142 may be mounted on or attached to an end 164 of the leaf spring. End 164 may include a receiving portion 166, which may include any suitable shape or structure configured to receive second locking element 142. For example, the receiving portion may be in the form of a dimple 168 to receive second locking element 142. Alternatively, end 164 of the leaf spring may include a hole or any other suitable structure configured to hold second locking element 142 and/or to urge the second locking element to the locking position or the unlocking position.

Although bias element 160 is shown to be in the form of a leaf spring, the bias element may be of any suitable type of bias element configured to urge second locking element 142 towards the unlocking position or the locking position, such as wire springs, coil springs, music wire, or other resilient material or structure. Additionally, although second locking element 142 is shown to be mounted on or attached to end 164 of leaf spring 162, the second locking element may not be mounted on or attached to the end of the leaf spring.

The locking mechanism also may include a follower member 148, which may include any suitable structure configured to move second locking element 142 between the locking position and the unlocking position. For example, as shown in FIGS. 7-9, follower member 148 may be in the form of a follower plate 150. The follower plate may be mounted for sliding movement in slot 134 of handle side panel 130 between a first position F and a second position S. In the first position, follower plate 150 moves end 164, or allows end 164 to move via bias element 160, which moves second locking element 142 into locking position L. In the second position, follower plate 150 moves end 164, or allows end 164 to move via bias element 160, into unlocking position U.

Follower plate 150 may include a contacting end portion 152 configured to contact end 164 of bias element 160 thereby moving the second locking element between the locking and the unlocking positions. For example, contacting end portion 152 may include an inclined surface 154 configured to move end 164 of bias element 160, thereby moving ball bearing 146 between locking position L and unlocking position U, as the follower plate is moved between the first position and the second position.

The follower plate also may include an actuator 156 manipulable from outside handle 124 and may include any suitable structure configured to allow a user to slide follower plate 150 between the first position and the second position. For example, actuator 156 may be in the form of a screw 158, which allows the user to selectively slide follower plate 150 from outside handle 122. Additionally, actuator 156 may secure follower plate 150 within slot 134 of handle 122.

Although follower member 148 is shown to include a specific shape and structure, any suitable shape and structure may be used configured to move second locking element 142 between the locking position and the unlocking position U. Additionally, although follower member 148 is shown to be slidingly mounted on handle 122, the follower member may be pivotally mounted or mounted in any other suitable way configured to move second locking element 142 between the locking position and the unlocking position U. Furthermore, although follower member 148 is shown to move end 164 of bias element 160 thereby moving second locking element 142, the follower member may be configured to move the second locking element directly.

Although the folding knives and features of folding knives has been shown and described with reference to the foregoing operational principles and preferred embodiments, those skilled in the art will find apparent that various changes in form and detail may be made without departing from the spirit and scope of the claims. The present disclosure is intended to embrace all such alternatives, modifications, and variances that fall within the scope of the appended claims.

1. A folding knife, comprising:
a handle;
a blade pivotally connected to the handle in a manner allowing pivoting of the blade between a closed position in which the blade extends along the handle, and an open position in which the blade extends away from the handle, wherein the blade includes a tang having a first locking element;
a second locking element disposed within the handle; and
a third locking element configured to move between a locking position in which the third locking element engages at least part of the first locking element and at least part of the second locking element in a manner preventing pivoting of the blade relative to the handle, and an unlocking position in which the blade is free to pivot from the closed position to the open position, wherein the third locking element is configured to move free from a bias element.

2. The folding knife of claim 1, wherein the first locking element includes a hole configured to receive at least part of the second locking element.

3. The folding knife of claim 1, wherein the second locking element includes a recess within the handle.

4. The folding knife of claim 1, wherein the blade pivots around a pivot axis and the third locking element moves along a line parallel to the pivot axis.

5. The folding knife of claim 1, wherein the third locking element includes a ball bearing.

6. The folding knife of claim 1, wherein the third locking element engages one of the first locking element and the second locking element when the third locking element is in the unlocking position.

7. The folding knife of claim 1, further comprising a follower member configured to move the third locking element between the locking position and the unlocking position.

8. The folding knife of claim 7, wherein the follower member is slidingly mounted within the handle.

9. The folding knife of claim 7, wherein the follower member includes an end portion, and the end portion is configured to move the second locking element between the locking position and the unlocking position.

10. The folding knife of claim 9, wherein the end portion includes an inclined surface.

11. The folding knife of claim 9, wherein the follower member is configured to be manipulable from outside the handle.

12. A folding knife, comprising:
a handle including at least one handle side;
a blade connected to the handle in a manner allowing movement of the blade between a closed position in which the blade extends along the handle, and an open position in which the blade extends away from the handle, wherein the blade includes a tang having a first locking element; and
a second locking element attached to the at least one handle side and configured to move between a locking position in which the second locking element engages at least part of the first locking element in a manner preventing pivoting of the blade relative to the handle, and an unlocking position in which the blade is free to pivot from the closed position to the open position.

13. The folding knife of claim 12, wherein the first locking element includes a hole configured to receive at least part of the second locking element.

14. The folding knife of claim 12, wherein the at least one handle side includes at least one liner, and the second locking element is attached to the at least one liner.

15. The folding knife of claim 14, wherein the at least one liner is configured to urge the second locking element towards the unlocking position.

16. The folding knife of claim 12, wherein the second locking element includes a ball bearing.

17. The folding knife of claim 12, further comprising a follower member configured to move the second locking element between the locking position and the unlocking position.

18. The folding knife of claim 17, wherein the follower member is slidingly mounted within the handle.

19. The folding knife of claim 17, wherein the follower member includes an end portion, and the end portion is configured to move the second locking element between the locking position and the unlocking position.

20. The folding knife of claim 19, wherein the end portion includes an inclined surface.

21. The folding knife of claim 19, wherein the follower member is configured to be manipulable from outside the handle.

22. A folding knife, comprising:
a handle;
a blade pivotally connected to the handle in a manner allowing pivoting of the blade between a closed position in which the blade extends along the handle, and an open position in which the blade extends away from the handle, wherein the blade includes a tang; and
a locking mechanism, comprising
a ball bearing disposed within the handle,
a hole in the tang of the blade, and
a follower member slidingly mounted to the handle and configured to move the ball bearing between a locking position in which the ball bearing engages at least part of the hole in a manner preventing pivoting of the blade relative to the handle, and an unlocking position in which the blade is free to pivot.

23. The folding knife of claim 22, wherein the handle includes at least one handle side, and the ball bearing is attached to the handle side.

24. The folding knife of claim 23, wherein the at least one handle side includes at least one liner, and the ball bearing is attached to the at least one liner.

25. The folding knife of claim 24, wherein the at least one liner is configured to urge the ball bearing away from the hole.

26. The folding knife of claim 22, wherein the locking mechanism is free from a bias element.
